(19) United States
(12) Patent Application Publication
(10) Pub. No.: US 2018/0152559 A1
(43) Pub. Date: May 31, 2018

(54) ESTABLISHING A TEMPORALLY FOLLOWING VOICE CONNECTION OF A USER OF A CALL CENTER FACILITY TO THE CALL CENTER FACILITY AFTER A TEMPORALLY PRECEDING VOICE CONNECTION OF THE USER TO THE CALL CENTER FACILITY HAS BEEN ESTABLISHED AND HAS ENDED

(71) Applicant: Deutsche Telekom AG, Bonn (DE)

(72) Inventors: Bert Kaufmann, Muenster (DE); Henriette Jehnert, Bonn (DE); Gero Niemeyer, Cologne (DE); Franz Weisenburger, Bad Honnef (DE)

(21) Appl. No.: 15/811,704

(22) Filed: Nov. 14, 2017

(30) Foreign Application Priority Data
Nov. 25, 2016 (EP) 16 200 639.9

(51) Int. Cl. H04M 3/48; H04M 3/42; H04M 3/424

(52) U.S. Cl. CPC H04M 3/48; H04M 3/42195; H04M 2203/2072; H04M 3/42382; H04M 3/424

(57) ABSTRACT

A method for establishing a temporally following voice connection of a user of a call center facility to the call center facility after a temporally preceding voice connection of the user to the call center facility has been established and has ended, wherein the temporally following voice connection relates to the temporally preceding voice connection, includes: in a first step, the temporally preceding voice connection between the user and the call center facility is established; in a second step that follows the first step, the temporally preceding voice connection is ended; in a third step that follows the second step, a text-oriented message is transmitted to the user, wherein the text-oriented message indicates the possibility of establishing the temporally following voice connection that relates to the temporally preceding voice connection; and in a fourth step that follows the third step, the temporally following voice connection is established.

### CROSS-REFERENCE TO RELATED APPLICATIONS

Priority is claimed to European Patent Application No. EP 16 200 639.9, filed on Nov. 25, 2016, the entire disclosure of which is hereby incorporated by reference herein.

### FIELD

The invention relates to a method for establishing a temporally following voice connection of a user of a call center facility to the call center facility after a temporally preceding voice connection of the user to the call center facility has been established and has ended, the temporally following voice connection relating to the temporally preceding voice connection.

The invention further relates to a call center facility for establishing a temporally following voice connection of a user of the call center facility to the call center facility after a temporally preceding voice connection of the user to the call center facility has been established and has ended, the call center facility being designed such that the temporally following voice connection relates to the temporally preceding voice connection.

Furthermore, the invention also relates to a computer program comprising program code, and to a computer program product comprising a computer-readable medium and a computer program that is stored on the computer-readable medium and comprises program code for establishing a temporally following voice connection of a user of a call center facility to the call center facility after a temporally preceding voice connection of the user to the call center facility has been established, the program code being able to be used such that all the steps of the method according to the invention can be carried out.

### BACKGROUND

Methods for providing customer support using a call center facility are conventional in many business divisions by various service providers, retail groups, etc.

Typically, the service provider provides a telecommunications number on which a customer can reach an employee of the service provider. Questions regarding a specific service, a product, provision of a product or the like can then be answered by the call center facility employee. In what follows, information regarding a service, information regarding a question about a product, or help regarding a technical problem can be passed on to the customer that is calling. In this context, call center facilities fulfill an essential part of the customer advisory service in a plurality of service sectors and in retail.

The economic success of a service provider is therefore closely linked to the specialist/technical quality of the advice provided by the employees of a call center facility associated with the service provider, and also to the customer's perception of the quality of the service, where, in addition to the technical quality, social components may also play a role.

Methods of this kind disclosed in the prior art are disadvantageous inter alia because, if further calls to the call center facility regarding the customer's request are required or desired, said customer is connected to any employee of the call center facility. As a result, in many cases optimal technical advice may not be given, and a personal relationship between the call center facility employee and the customer may not be established, which may reduce the customer's level of satisfaction with the advice.

Furthermore, methods are disclosed in the prior art in which, in the event of a second call, a user of a call center facility is transferred, via information transmission, to the same employee of the call center who had also answered the user's preceding call. However, methods of this kind disclosed in the prior art have various disadvantages. Inter alia, direct transfer to a specific employee in the event of the user's second call is possible only if the employee is also available at that point in time. This may not be the case in particular if said employee is advising another customer, is currently not working, or is otherwise engaged when the second call is received.

### SUMMARY

In an exemplary embodiment, the present invention provides a method for establishing a temporally following voice connection of a user of a call center facility to the call center facility after a temporally preceding voice connection of the user to the call center facility has been established and has ended. The temporally following voice connection relates to the temporally preceding voice connection. The method comprises the following steps: in a first step, the temporally preceding voice connection between the user and the call center facility is established; in a second step that follows the first step, the temporally preceding voice connection is ended; in a third step that follows the second step, a text-oriented message is transmitted to the user, wherein the text-oriented message indicates the possibility of establishing the temporally following voice connection that relates to the temporally preceding voice connection; and in a fourth step that follows the third step, the temporally following voice connection is established.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows a user contacting a call center facility according to an embodiment of the invention; and

FIG. 2 is a schematic communication diagram according to an embodiment of the invention.

### DETAILED DESCRIPTION

Exemplary embodiments of the invention provide a method for providing improved technical advice for a user via a call center facility, and/or for increasing the user's perceived level of satisfaction with the advice during communication with a call center facility.

In an exemplary embodiment, the invention provides a method for establishing a temporally following voice connection of a user of a call center facility to the call center facility after a temporally preceding voice connection of the user to the call center facility has been established and has ended, the temporally following voice connection relating to the temporally preceding voice connection, the method comprising the following steps:
in a first step, the temporally preceding voice connection between the user and the call center facility is established,
in a second step that follows the first step, the temporally preceding voice connection is ended,
in a third step that follows the second step, a text-oriented message is transmitted to the user, the text-oriented message indicating the possibility of establishing the temporally following voice connection that relates to the temporally preceding voice connection,
in a fourth step that follows the third step, the temporally following voice connection is established.

According to the invention, it is thus advantageously possible for a user of a call center facility (i.e. for example a customer of a service provider) to be made aware of the possibility of establishing a temporally following voice connection to a call center facility, after a temporally preceding voice connection to the call center facility (and/or to an employee of a call center facility of this kind) has already been established (and therefore, in a variant of the invention, a temporally preceding consultation has already taken place). This is advantageous, for example, if not all the questions or problems of the user of the call center facility could be answered or solved during the temporally preceding voice connection, or if new questions or problems (regarding a related topic) arise for the user after the temporally preceding voice connection.

Furthermore, it is thus advantageously possible for the user to thus be made aware of the possibility of establishing a temporally following voice connection to the call center facility, if further steps regarding a problem have been agreed between the user and the call center facility during the temporally preceding voice connection, which further steps require action on the part of the call center facility or a service provider associated with the call center facility. As a result, the user is able to discuss further/new questions or problems (resulting from the action of the call center or of the service provider) with the call center facility, and/or to receive advice thereon. In an embodiment of the invention, the user is informed of this possibility of establishing a temporally following voice connection via a text-oriented message. This is helpful in particular if the temporally preceding voice connection was initiated by the user via a mobile communications device (and/or a device that supports the display of a text-oriented message, such as a mobile telephone, a tablet, etc.).

According to an embodiment of the method according to the invention, it is provided for a plurality of individuals implementing voice connections to be associated with the call center facility, and for the reference of the temporally following voice connection to the temporally preceding voice connection to relate to the individuals of the call center facility implementing the voice connections,
either one specific individual of the plurality of individuals implementing voice connections implementing both the temporally preceding voice connection to the user and the temporally following voice connection to the user,
or the specific individual of the plurality of individuals implementing voice connections implementing the temporally preceding voice connection to the user and, in the event that the specific individual cannot be reached, a further individual implementing the temporally following voice connection to the user, the further individual being a representative of the specific individual.

According to the invention, it is thus advantageously possible for a plurality of individuals implementing voice connections to be associated with the call center facility. According to an embodiment of the present invention, in this case the temporally following voice connection is implemented by the same specific individual from the plurality of individuals implementing voice connections (and/or the same call center facility employee) as the temporally preceding voice connection. This advantageously makes it possible, according to the invention, for the call center facility employee participating in the temporally following voice connection to already be known to the user of the call center facility. This can be advantageous for the bond of trust between the user and the call center facility employee, and can thus increase the user's satisfaction with the method. Furthermore, the call center facility employee is already familiar with the user's technical problem, which facilitates the technical advice and may be advantageous for the speed and the quality of the advice.

According to the invention, it is furthermore advantageously possible, in this case, for the temporally following voice connection to be implemented by a further individual from the plurality of individuals implementing voice connections, said further individual not being the individual who implemented the temporally preceding voice connection, but instead an individual representing the individual who implemented the temporally preceding voice connection. This can be very advantageous in particular if the individual who implemented the temporally preceding voice connection cannot be reached (for example is on holiday, is carrying out another task making said individual unavailable, etc.).

According to an embodiment of the method according to the invention, it is provided that, in a fifth step that follows the third step and precedes the fourth step, the establishment of the temporally following voice connection is initiated or at least requested, the establishment of the temporally following voice connection occurring in at least one of the following ways:
in the fifth step, a voice connection of the user to the call center facility is set up, and subsequently the temporally following voice connection is established without interrupting the voice connection set up in the fifth step,
in the fifth step, a voice connection of the user to the call center facility is set up and ended and, in the following fourth step, the temporally following voice connection is established by a call-back from the call center facility to the user,
in the fifth step, a further text-oriented message is transmitted from the user to the call center facility and, in the following fourth step, the temporally following voice connection is established by a call from the call center facility to the user,
in the fifth step, the user interacts with a page or application that is associated with the call center facility and can be reached via the Internet and, in the following fourth step, the temporally following voice connection is established by a call from the call center facility to the user.

According to an embodiment of the invention of this kind comprising a fifth step that follows the third step and precedes the fourth step, the method according to the invention advantageously makes it possible for the establishment of the temporally following connection to be initiated or at least requested. In this case, the temporally following voice connection can be established in various ways. This embodiment of the method according to the invention facilitates the establishment of the temporally following voice connection and can be advantageous for the user's perception of satisfaction.

According to an embodiment of the invention it is thus possible, for example, for the temporally following voice connection to be established without interrupting a voice connection to the call center facility established by the user in a fifth step.

Furthermore, according to a further alternative embodiment of the invention, in a fifth step, a voice connection of the user to the call center facility is set up and ended and, in the following fourth step, the temporally following voice connection is then established by a call from the call center facility to the user. This makes it possible, according to the invention, for a specific individual (an employee of the call center) associated with the call center facility who had already participated in the temporally preceding voice connection to call the user back if said specific individual cannot be immediately reached during a fifth step, for example at or during a time interval after the establishment of the voice connection.

Furthermore, according to a further alternative embodiment of the invention, in a fifth step, a further text-oriented message is transmitted from the user to the call center facility and, in the following fourth step, the temporally following voice connection is established by a call from the call center facility to the user. It is thus advantageously possible for the user to also be able to communicate to the call center facility, according to a fourth step, his wishes regarding a temporally following voice connection without a voice connection being triggered in a fifth step.

Furthermore, according to a further alternative embodiment of the invention, in a fifth step, the user interacts with a page or application that is associated with the call center facility and can be reached via the Internet and, in the following fourth step, the temporally following voice connection is then established by a call from the call center facility to the user. This advantageously makes it possible for the user to also be able to communicate to the call center facility, according to a fourth step, his wishes regarding a further temporally following voice connection without a voice connection being triggered in a fifth step. In this case, according to an embodiment of the invention, it is in particular possible for the user to use an Internet page (an Internet portal) for this purpose. According to an embodiment of the invention, it is also possible for an application that allows communication via the Internet to be used for this purpose in a fifth step.

According to an embodiment of the method according to the invention, it is provided for a time specification from the user for establishing the temporally following voice connection to be transmitted to the call center facility in the fifth step, the time specification comprising information that the user is available in one or more future time windows for the establishment of the temporally following voice connection.

Thus, advantageously, the user indicates, in a fifth step, his preferred time specification for when the temporally following voice connection can or should be established. The user's time preference is thus available to the call center facility and/or to an individual associated with the call center facility (for example an employee of the call center facility) after a fifth step, and the temporally following voice connection can advantageously take place in a time period preferred by the user.

According to an embodiment of the invention, in the fifth step the user has the option of informing the call center facility of whether he wishes to be connected, in a temporally following conversation, to the specific individual who was involved in carrying out the temporally preceding conversation. The user transmits text-oriented information or audio information, for example, to the call center facility, which information indicates whether the user wishes to be connected, in a temporally following conversation, to the specific individual who was involved in carrying out the temporally preceding conversation.

According to an embodiment of the method according to the invention, it is provided for a time proposal by the call center facility for establishing the temporally following voice connection to be transmitted to the user in the fifth step, the time proposal comprising at least one of the following items of information:
information regarding the availability of the specific individual,
information indicating that the specific individual is available for establishing the temporally following voice connection in one or more further future time windows,
information indicating that the further individual is available for establishing the temporally following voice connection in one or more further future time windows.

Thus, according to an embodiment of the invention, the user is advantageously informed, during a fifth step, of the time period (or time periods) in which the individual who implemented the temporally preceding voice connection to the user (or who participated in said temporally preceding voice connection) is available for a temporally following voice connection. This facilitates the temporal planning of the temporally following voice connection, and leads to increased satisfaction for the user of the call center facility.

According to an embodiment of the method according to the invention, it is provided for the text-oriented message transmitted to the user in the third step and/or the further text-oriented message transmitted to the call center facility in the fifth step to correspond to at least one of the following messages:
an SMS message (short message service message)
an MME message (multimedia message)
an e-mail message
a message transmitted within the context of a social network
a message transmitted via a messaging service.

It is thus possible, according to the invention, for the text-oriented messages transmitted during a third step and/or during a fifth step (to the user in a third step; to the call center facility in a fifth step) to correspond in each case to an SMS message, an MME message, an e-mail message, a message transmitted within the context of a social network (for example via an application on a mobile telephone, a tablet, etc.), and/or a message transmitted via a messaging service. Thus, according to the invention, a plurality of manifestations of text-based messages are available to the user and the call center facility for mutual communication. This provides significant technical advantages, since a wide range of user preferences can be addressed, and/or a form of text-based message suitable for the communications device used by the user can be selected.

According to an embodiment of the method according to the invention, it is provided for a telephone number or identification information of the user that is to be used for establishing the temporally following voice connection to be transmitted to the call center facility in the fifth step.

It is thus possible, according to the invention, for the call center facility to receive, during a fifth step, information regarding the telephone number that is preferably to be used for the temporally following voice connection. Alternatively, another item of identification information is also transmitted in this case (for example name information, an identification number that allows the call center facility to identify the user, or an identification number that relates to the temporally preceding conversation and via which the user can be identified by the call center facility). It is thus advantageously possible for a telephone number or an item of information to be made available to the call center facility during the fifth step, on the basis of which number or information the call center can determine a telephone number that is suitable (or desired by the user) and that is then used for the temporally following voice connection.

According to an embodiment of the method according to the invention, it is provided for the temporally following voice connection to be established in the fourth step only if the fifth step occurs within a predetermined time interval after the temporally preceding voice connection.

A time interval is thus advantageously specified, within which the fifth step must be initiated or carried out after the temporally preceding voice connection. According to an embodiment of the invention it is thus possible to ensure, for example, that a user is reconnected to the same call center facility employee who had implemented the temporally preceding voice connection (or participated therein) only during a specified time period after the temporally preceding voice connection. It is thus possible to ensure, for example, that a connection to the same call center facility employee is not reestablished after an excessively long time period (such that, in normal cases, when the user uses the call center facility again there is no relation/only a weak relation to the previous use, and/or such that the user would, in many cases, no longer remember the previous voice connection in detail).

Furthermore, according to another embodiment of the invention, it is provided for the user to be made aware by the call center, during the second step, of the possibility of establishing the temporally following voice connection that relates to the temporally preceding voice connection.

In a further exemplary embodiment, the invention provides a call center facility for establishing a temporally following voice connection of a user of the call center facility to the call center facility after a temporally preceding voice connection of the user to the call center facility has been established and has ended, the call center facility being designed such that the temporally following voice connection relates to the temporally preceding voice connection, and further being designed such that
the temporally preceding voice connection between the user and the call center facility is established and ended,
a text-oriented message is transmitted to the user, the text-oriented message indicating the possibility of establishing the temporally following voice connection that relates to the temporally preceding voice connection,
the temporally following voice connection is established.

It is thus advantageously possible, according to the invention, for a user of a call center facility (i.e. for example a customer of a service provider) to be made aware of the possibility of establishing a temporally following voice connection to a call center facility, after a temporally preceding voice connection to the call center facility (and/or to an employee of a call center facility of this kind) has already been established (and therefore, in a variant of the invention, a temporally preceding consultation has already taken place). This is advantageous, for example, if not all the questions or problems of the user of the call center facility could be answered or solved during the temporally preceding voice connection, or if new questions or problems (regarding a related topic) arise for the user after the temporally preceding voice connection.

Furthermore, it is thus advantageously possible for the user to thus be made aware of the possibility of establishing a temporally following voice connection to the call center facility, if further steps regarding a problem have been agreed between the user and the call center facility during the temporally preceding voice connection, which further steps require action on the part of the call center facility or a service provider associated with the call center facility. As a result, the user is able to discuss further/new questions or problems (resulting from the action of the call center or of the service provider) with the call center facility, and/or to receive advice thereon. In an embodiment of the invention, the user is informed of this possibility of establishing a temporally following voice connection via a text-oriented message. This is helpful in particular if the temporally preceding voice connection was initiated by the user via a mobile communications device (and/or a device that supports the display of a text-oriented message, such as a mobile telephone, a tablet, etc.).

According to an embodiment of the call center facility according to the invention, it is provided for a plurality of individuals implementing voice connections to be associated with the call center facility, and for the reference of the temporally following voice connection to the temporally preceding voice connection to relate to the individuals of the call center facility implementing the voice connections,
either one specific individual of the plurality of individuals implementing voice connections implementing both the temporally preceding voice connection to the user and the temporally following voice connection to the user,
or the specific individual of the plurality of individuals implementing voice connections implementing the temporally preceding voice connection to the user and, in the event that the specific individual cannot be reached, a further individual implementing the temporally following voice connection to the user, the further individual being a representative of the specific individual.

According to the invention, it is thus advantageously possible for a plurality of individuals implementing voice connections to be associated with the call center facility. According to an embodiment of the present invention, in this case the temporally following voice connection is implemented by the same specific individual from the plurality of individuals implementing voice connections (and/or the same call center facility employee) as the temporally preceding voice connection. This advantageously makes it possible, according to the invention, for the call center facility employee participating in the temporally following voice connection to already be known to the user of the call center facility. This can be advantageous for the bond of trust between the user and the call center facility employee, and can thus increase the satisfaction for the user. Furthermore, the call center facility employee is already familiar with the user's technical problem, which facilitates the technical advice and may be advantageous for the speed and the quality of the advice.

According to the invention, it is furthermore advantageously possible, in this case, for the temporally following voice connection to be implemented by a further individual from the plurality of individuals implementing voice connections, said further individual not being the individual who implemented the temporally preceding voice connection, but instead an individual representing the individual who implemented the temporally preceding voice connection. This can be very advantageous in particular if the individual who implemented the temporally preceding voice connection cannot be reached (for example is on holiday, is carrying out another task making said individual unavailable, etc.).

According to an embodiment of the call center facility according to the invention, it is provided for the call center facility to be designed such that the establishment of the temporally following voice connection is initiated or at least requested, and for said facility to further be designed such that the establishment of the temporally following voice connection occurs in at least one of the following ways:
a voice connection of the user to the call center facility is set up, and subsequently the temporally following voice connection is established without interrupting the voice connection set up,
a voice connection of the user to the call center facility is set up and ended, and the temporally following voice connection is established by a call-back from the call center facility to the user,
a further text-oriented message is transmitted from the user to the call center facility, and the temporally following voice connection is established by a call from the call center facility to the user,
the user interacts with a page or application that is associated with the call center facility and can be reached via the Internet, and the temporally following voice connection is established by a call from the call center facility to the user.

According to an embodiment of the invention of this kind comprising a fifth step that follows the third step and precedes the fourth step, the call center facility according to the invention advantageously makes it possible for the establishment of the temporally following connection to be initiated or at least requested. In this case, the temporally following voice connection can be established in various ways. This embodiment of the call center facility according to the invention facilitates the establishment of the temporally following voice connection and can be advantageous for the user's perception of satisfaction.

According to an embodiment of the invention it is thus possible, for example, for the temporally following voice connection to be established without interrupting a voice connection to the call center facility established by the user in a fifth step.

Furthermore, according to a further alternative embodiment of the invention, in a fifth step, a voice connection of the user to the call center facility is set up and ended and, in the following fourth step, the temporally following voice connection is then established by a call from the call center facility to the user. This makes it possible, according to the invention, for a specific individual (an employee of the call center) associated with the call center facility who had already participated in the temporally preceding voice connection to call the user back if said specific individual cannot be immediately reached during a fifth step, for example at or during a time interval after the establishment of the voice connection.

Furthermore, according to a further alternative embodiment of the invention, in a fifth step, a further text-oriented message is transmitted from the user to the call center facility and, in the following fourth step, the temporally following voice connection is established by a call from the call center facility to the user. It is thus advantageously possible for the user to also be able to communicate to the call center facility, according to a fourth step, his wishes regarding a temporally following voice connection without a voice connection being triggered in a fifth step.

Furthermore, according to a further alternative embodiment of the invention, in a fifth step, the user interacts with a page or application that is associated with the call center facility and can be reached via the Internet and, in the following fourth step, the temporally following voice connection is then established by a call from the call center facility to the user. This advantageously makes it possible for the user to also be able to communicate to the call center facility, according to a fourth step, his wishes regarding a further temporally following voice connection without a voice connection being triggered in a fifth step. In this case, according to an embodiment of the invention, it is in particular possible for the user to use an Internet page (an Internet portal) for this purpose. According to an embodiment of the invention, it is also possible for an application that allows communication via the Internet to be used for this purpose in a fifth step.

The present invention further relates to a computer program comprising program code, using which all the steps of the method according to the invention can be carried out when the computer program is executed on a programmable facility, in particular the call center facility, or is executed as a part of the call center facility.

The present invention further relates to a computer program product comprising a computer-readable medium and a computer program that is stored on the computer-readable medium and comprises program code for establishing a temporally following voice connection of a user of a call center facility to the call center facility after a temporally preceding voice connection of the user to the call center facility has been established, the program code being able to be used such that all the steps of the method according to the invention can be carried out when the computer program is executed on a programmable facility, in particular the call center facility, or is executed as a part of the call center facility.

Further details, features and advantages of the invention can be found in the drawings and in the following description of preferred embodiments with reference to the drawings. In this case, the drawings illustrate embodiments of the invention that are given merely by way of example and that do not restrict the essential inventive concept.

The present invention will be described with reference to specific embodiments and with reference to the accompanying drawings, the invention not being restricted to these embodiments and to these drawings, however, but instead being specified by the claims. The drawings are not limiting. In the drawings, for purposes of representation, certain elements may be shown enlarged and/or exaggerated, and may not be shown to scale.

If nothing is specifically stated to the contrary, the use of an indefinite or definite article with reference to a word in the singular, for example “a”, “an”, “the” also comprises the plurality of such a word. The designations “first”, “second”, etc. in the description and in the claims are used to distinguish between similar elements or between the same elements that are to be differentiated, and not necessarily to describe a temporal or other sequence. The terms used in this way are in principle to be considered interchangeable under corresponding conditions.

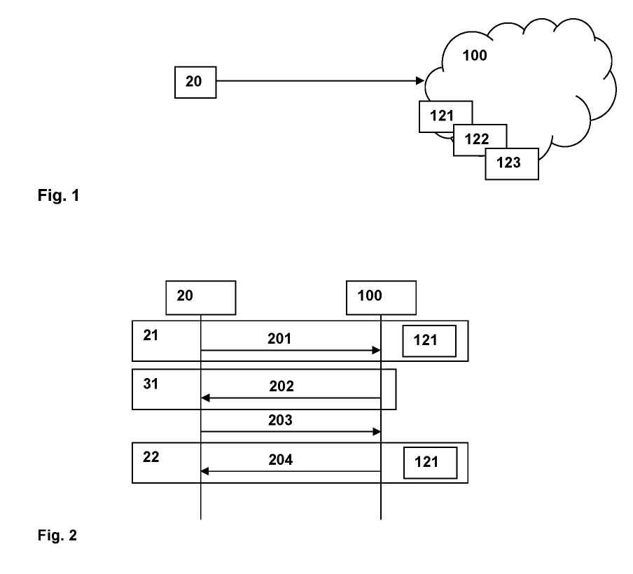

FIG. 1 schematically shows a user 20 who is contacting a call center facility 100, according to an embodiment of the invention. In particular, a user 20 of a call center facility 100, a call center facility 100, and a plurality of individuals 121, 122, 123 who implement voice connections and are associated with the call center facility 100, are shown. In this case, the arrow indicates the communication between the user and the call center facility 100 and/or between the user 20 and at least one individual of the plurality of individuals 121, 122, 123 implementing voice connections.

FIG. 2 is a schematic communication diagram according to an embodiment of the invention. In a first step, a temporally preceding voice connection 21 is set up between a user 20 and a specific individual 121 from a plurality of individuals 121, 122, 123 who implement voice connections and are associated with the call center facility 100. For this purpose, in a first process step 201 the user 20 initiates the establishment of a voice connection between the user 20 and the call center facility 100. After the temporally preceding voice connection 21 has been set up, a conversation then takes place between the user and the specific individual 121, the conversation relating to a specific request of the user 20 (for example a technical question regarding a product or a service, a problem with a product or a service, desired information regarding a product or a service, etc.). In what follows, the temporally preceding voice connection 21 between the user 20 and the specific individual 121 is ended. Subsequently, in second process step 202, a text-oriented message 31, for example an SMS message (short message service message), an MME message (multimedia message), an e-mail message, a message transmitted within the context of a social network (for example provided via an application on a mobile telephone, a tablet, etc.), or a message transmitted via a messaging service, is transmitted from the call center facility 100 to the user 20. The text-oriented message 31 makes the user 20 aware of the possibility of establishing a temporally following voice connection 22 relating to the temporally preceding voice connection 21 he wishes to be connected, in a temporally following conversation, to the specific individual who was involved in carrying out the temporally preceding conversation. Subsequently, according to an embodiment of the invention, in a third process step 203 the user 20 requests a following voice connection 22 from the call center facility 100. This request is initiated for example by the user 20 setting up a voice connection. According to another embodiment of the invention, this request is made via a further text-oriented message that the user 20 sends to the call center facility 100. In this case, said further text-oriented message is, for example, an SMS message (short message service message), an MME message (multimedia message), an e-mail message, a message transmitted within the context of a social network (for example provided via an application on a mobile telephone, a tablet, etc.), or a message transmitted via a messaging service. In this request, the user 20 informs the call center, for example, that he would like to be reconnected to the specific individual 121 in a temporally following voice connection 22. Furthermore, the user indicates whether he has a specific preference regarding a time interval in which the temporally following voice connection 22 should be established and/or specifies or communicates a specific telephone number to which the temporally following voice connection 22 should be set up. In what follows, according to an embodiment of the invention, in a fourth process step 204 the temporally following voice connection 22 is then initiated by the call center facility 100 and/or, if desired by the user 20, by the specific individual 121, such that a further conversation takes place (for example regarding a topic related or identical to that of the conversation that had taken place after setting up the temporally preceding voice connection).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for establishing a temporally following voice connection of a user of a call center facility to the call center facility after a temporally preceding voice connection of the user to the call center facility has been established and has ended, wherein the temporally following voice connection relates to the temporally preceding voice connection,
wherein the method comprises the following steps:
in a first step, the temporally preceding voice connection between the user and the call center facility is established;
in a second step that follows the first step, the temporally preceding voice connection is ended;
in a third step that follows the second step, a text-oriented message is transmitted to the user, wherein the text-oriented message indicates the possibility of establishing the temporally following voice connection that relates to the temporally preceding voice connection; and
in a fourth step that follows the third step, the temporally following voice connection is established.

2. The method according to claim 1, wherein a plurality of individuals implementing voice connections are associated with the call center facility, and the reference of the temporally following voice connection to the temporally preceding voice connection relates to the individuals of the call center facility implementing the voice connections;
wherein:
either one specific individual of the plurality of individuals implementing voice connections implementing both the temporally preceding voice connection to the user and the temporally following voice connection to the user; or
the specific individual of the plurality of individuals implementing voice connections implementing the temporally preceding voice connection to the user and, in the event that the specific individual cannot be reached, a further individual implementing the temporally following voice connection to the user, the further individual being a representative of the specific individual.

3. The method according to claim 1, wherein, in a fifth step that follows the third step and precedes the fourth step, the establishment of the temporally following voice connection is initiated or requested, the establishment of the temporally following voice connection occurring in at least one of the following ways:
in the fifth step, a voice connection of the user to the call center facility is set up, and subsequently the temporally following voice connection is established without interrupting the voice connection set up in the fifth step;
in the fifth step, a voice connection of the user to the call center facility is set up and ended and, in the following fourth step, the temporally following voice connection is established by a call-back from the call center facility to the user;
in the fifth step, a further text-oriented message is transmitted from the user to the call center facility and, in the following fourth step, the temporally following voice connection is established by a call from the call center facility to the user; or
in the fifth step, the user interacts with a page or application that is associated with the call center facility and can be reached via the Internet and, in the following fourth step, the temporally following voice connection is established by a call from the call center facility to the user.

4. The method according to claim 3, wherein, in the fifth step, a time specification from the user for establishing the temporally following voice connection is transmitted to the call center facility, the time specification comprising information that the user is available in one or more future time windows for the establishment of the temporally following voice connection.

5. The method according to claim 3, wherein, in the fifth step, a time proposal by the call center facility for establishing the temporally following voice connection is transmitted to the user, the time proposal comprising at least one of the following items of information:
information regarding the availability of the specific individual;
information indicating that the specific individual is available for establishing the temporally following voice connection in one or more further future time windows; or
information indicating that the further individual is available for establishing the temporally following voice connection in one or more further future time windows.

6. The method according claim 3, wherein the text-oriented message transmitted to the user in the third step and/or the further text-oriented message transmitted to the call center facility in the fifth step corresponds to at least one of the following messages:
an SMS message (short message service message);
an MME message (multimedia message);
an e-mail message;
a message transmitted within the context of a social network; or
a message transmitted via a messaging service.

7. The method according to claim 3, wherein, in the fifth step, a telephone number or identification information of the user that is to be used for establishing the temporally following voice connection is transmitted to the call center facility.

8. The method according to claim 3, wherein the temporally following voice connection is established in the fourth step based on the fifth step occurring within a predetermined time interval after the temporally preceding voice connection.

9. A non-transitory computer-readable medium having processor-executable instructions stored thereon for establishing a temporally following voice connection of a user of a call center facility to the call center facility after a temporally preceding voice connection of the user to the call center facility has been established and has ended, wherein the temporally following voice connection relates to the temporally preceding voice connection,
wherein the processor-executable instructions, when executed, facilitate performance of the following:
in a first step, the temporally preceding voice connection between the user and the call center facility is established;
in a second step that follows the first step, the temporally preceding voice connection is ended;
in a third step that follows the second step, a text-oriented message is transmitted to the user, wherein the text-oriented message indicates the possibility of establishing the temporally following voice connection that relates to the temporally preceding voice connection; and
in a fourth step that follows the third step, the temporally following voice connection is established.
